(19) United States
(12) Patent Application Publication
(10) Pub. No.: US 2022/0407843 A1
(43) Pub. Date: Dec. 22, 2022

(54) COMMUNICATION SYSTEM AND COMMUNICATION METHOD

(71) Applicant: KABUSHIKI KAISHA TOSHIBA, Tokyo (JP)

(72) Inventors: Yasuyuki TANAKA, Kawasakai Kanagawa (JP); Toshio ITO, Kawasaki Kanagawa (JP)

(73) Assignee: KABUSHIKI KAISHA TOSHIBA, Tokyo (JP)

(21) Appl. No.: 17/677,574

(22) Filed: Feb. 22, 2022

(30) Foreign Application Priority Data
Jun. 16, 2021 (JP) 2021-100282

(51) Int. Cl. H04L 9/40; H04L 9/30; H04L 67/04; H04L 9/32

(52) U.S. Cl. CPC H04L 63/0428; H04L 9/30; H04L 67/04; H04L 9/3213

(57) ABSTRACT

According to an embodiment, a communication system includes a device, a server apparatus, and a user terminal. A setting processing unit of the device executes operation setting processing of setting operation setting of the device when receiving authorization information generated by the server apparatus, from the user terminal. A communication unit of the device encrypts operation setting data transmitted from the device and transmits it to the user terminal. A communication unit of the server apparatus encrypts operation setting data transmitted from the server apparatus and transmits it to the user terminal. An acquisition unit of the user terminal performs authentication with the server apparatus, and acquires the authorization information from the server apparatus when the authentication succeeds. A transfer unit of the user terminal transfers the authorization information to the device and then transfers the operation setting data between the device and the server apparatus.

### CROSS-REFERENCE TO RELATED APPLICATIONS

This application is based upon and claims the benefit of priority from Japanese Patent Application No. 2021-100282, filed on Jun. 16, 2021; the entire contents of which are incorporated herein by reference.

### FIELD

Embodiments described herein relate generally to a communication system and a communication method.

### BACKGROUND

Techniques for connecting a device to a network are conventionally known. For example, in Wi-Fi Device Provisioning Protocol (DPP), a user terminal reads a QR code (registered trademark) displayed by a device, and then authentication is performed between the user terminal and the device based on information of the QR code (registered trademark). If the authentication succeeds, the user terminal transmits setting for connecting to an access point of a wireless LAN to the device.

### BRIEF DESCRIPTION OF THE DRAWINGS

FIG. 1 is a view illustrating an example of a device configuration of a communication system of a first embodiment;

FIG. 2 is a view illustrating an example of a functional configuration of a user terminal of the first embodiment;

FIG. 3 is a view illustrating an example of token management information of the first embodiment;

FIG. 4 is a view illustrating an example of a functional configuration of a device of the first embodiment;

FIG. 5 is a view illustrating an example of a functional configuration of a server apparatus of the first embodiment;

FIG. 6 is a view illustrating an example of user information of the first embodiment;

FIG. 7 is a sequence diagram illustrating an example of a communication method of the first embodiment;

FIG. 8 is a view illustrating an example of a functional configuration of a user terminal of a second embodiment; and

FIG. 9 is a view illustrating an example of a hardware configuration of main parts of a user terminal, a device, and a server apparatus of the first to fourth embodiments.

### DETAILED DESCRIPTION

According to an embodiment, a communication system includes a device, a server apparatus, and a user terminal. The device includes a setting processing unit, a communication unit, and an operation setting storage unit. The setting processing unit executes operation setting processing of setting operation setting of the device when receiving authorization information generated by the server apparatus, from the user terminal. The communication unit encrypts operation setting data to be transmitted from the device in the operation setting processing and transmits the encrypted operation setting data to the user terminal. The operation setting storage unit stores the operation setting set by the operation setting processing. The server apparatus includes a generation unit, and a communication unit. The generation unit generates the authorization information when authentication of the user terminal succeeds. The communication unit encrypts operation setting data to be transmitted from the server apparatus in the operation setting processing and transmits the encrypted operation setting data to the user terminal. The user terminal includes an acquisition unit, a transfer unit, and a communication unit. The acquisition unit performs the authentication with the server apparatus, and acquires the authorization information from the server apparatus when the authentication succeeds. The transfer unit transfers the authorization information to the device and then transfers the operation setting data between the device and the server apparatus. The communication unit receives a completion notification from at least one of the device and the server apparatus when the operation setting is completed.

Embodiments of a communication system and a communication method will be described below in detail with reference to the accompanying drawings.

Example of Device Configuration

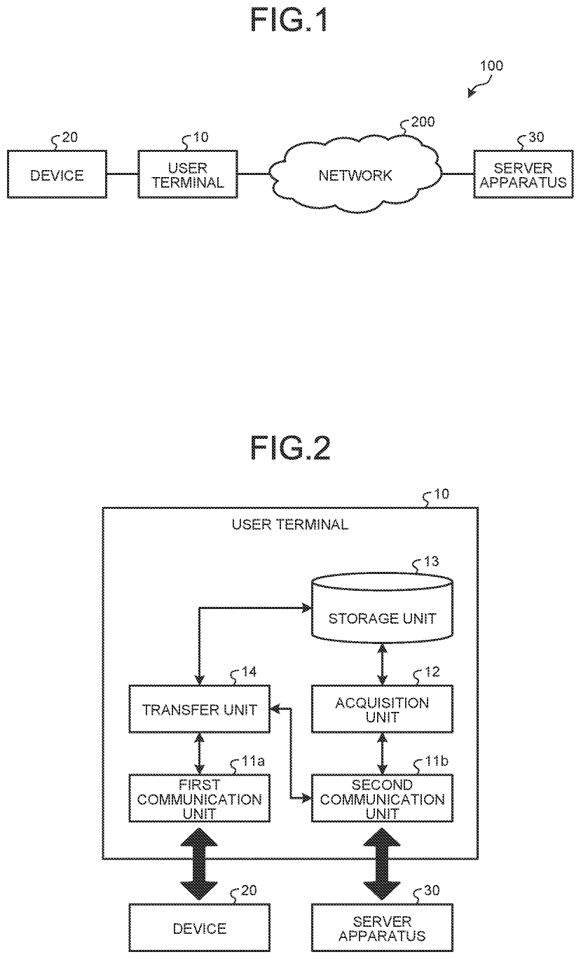

FIG. 1 is a view illustrating an example of a device configuration of a communication system 100 of a first embodiment. The communication system 100 of the first embodiment includes a user terminal 10, a device 20, a server apparatus 30, and a network 200.

The user terminal 10 and the device 20 are connected in a wired or wireless manner. In the wired manner, use of an RS-232C cable, a USB cable, an Ethernet cable, or the like is conceivable; however, the present invention is not limited thereto. In the wireless manner, use of Bluetooth, Wi-Fi, IEEE 802.15.4, infrared communication, ultrasonic communication, or the like is conceivable; however, it is not limited thereto.

The user terminal 10 is connected to the server apparatus 30 via the network 200.

The network 200 may be arbitrary. The network 200 is, for example, a wide area network such as the Internet. Further, for example, the network 200 is a wide closed area network. Furthermore, for example, the network 200 is a local network such as an intra-company network.

The device 20 may be arbitrary. For example, the device 20 is an edge device or the like used for an infrastructure service. Specifically, the device 20 is, for example, a sensor, an Internet of Things (IoT) device, or the like.

A method of realizing the server apparatus 30 may be arbitrary. The server apparatus 30 is realized by using, for example, a conventional server computer. Further, for example, the server apparatus 30 is realized as a virtual server obtained by virtualizing a physical server using a server virtualization technology. Furthermore, for example, the function of the server apparatus 30 is realized as a cloud service.

Example of Functional Configuration of User Terminal

FIG. 2 is a view illustrating an example of a functional configuration of the user terminal 10 of the first embodiment. The user terminal 10 of the first embodiment includes a first communication unit 11a, a second communication unit 11b, an acquisition unit 12, a storage unit 13, and a transfer unit 14.

The first communication unit 11a communicates with the device 20 by a first communication scheme.

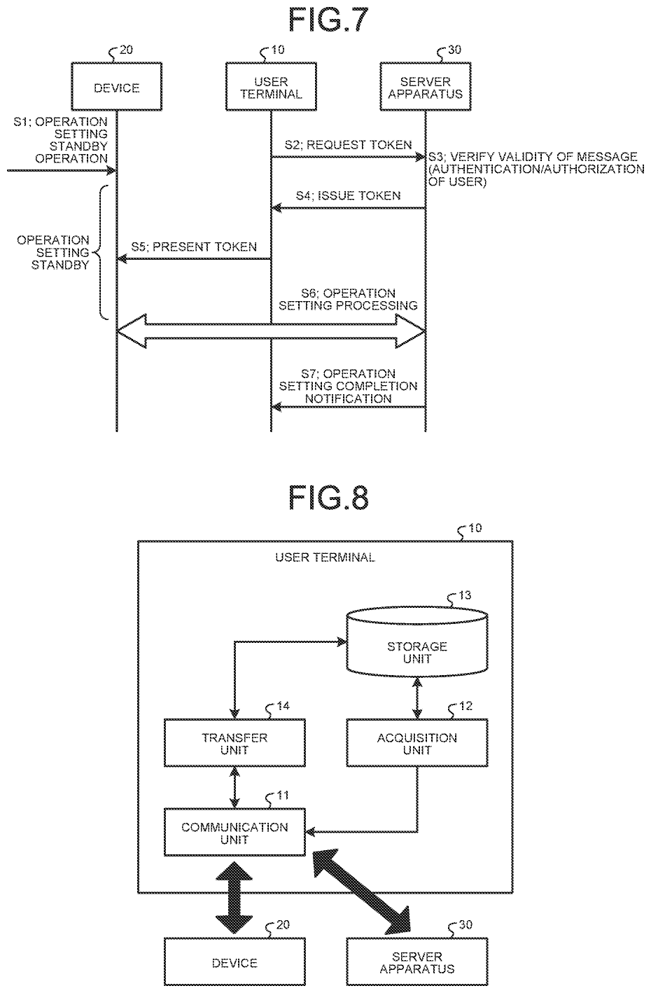

The second communication unit 11b communicates with the server apparatus 30 by a second communication scheme. When the first communication scheme and the second communication scheme are the same, the first communication units 11a and 11b may be realized as one communication unit 11 (see FIG. 8 of the second embodiment).

The acquisition unit 12 communicates with the server apparatus 30 and acquires a token (an example of authorization information) from the server apparatus 30. The acquisition unit 12 transmits a token request to the server apparatus 30 when requesting the token to the server apparatus 30. The token request includes at least one of information of the user terminal 10, information of a user who is a user of the user terminal 10, and information of a device communicating in the first communication unit 11a.

The information of the user terminal 10 includes, for example, a model and a serial number of the user terminal 10, a version of a related application, and the like.

The user information includes, for example, a user name, a password, a user certificate, and the like.

The device information includes, for example, a model, a serial number, a MAC address, and the like of the device 20. For example, the device information is specified from a name plate or the like of the device 20 and input to the user terminal 10 by the user. Further, for example, the device information is encoded into a QR code (registered trademark) or the like and read by using a camera or the like of the user terminal 10. The QR code (registered trademark) may be attached to a housing of the device 20, for example, or may be displayed on a display unit of the device 20. Furthermore, for example, the device information may be received from the device 20 via the first communication unit 11a.

In the communication performed by the acquisition unit 12 to obtain the token from the server apparatus 30, additional exchange for preventing an attack from an attacker may occur. For example, the acquisition unit 12 may authenticate the server apparatus 30 with a server certificate, or may transmit the token request further including a nonce, acquired in advance from the server apparatus 30, to the server apparatus 30. In any case, it is assumed that the information of the user terminal 10, the user information, the device information, and the like transmitted from the acquisition unit 12 to the server apparatus 30 are sufficiently protected from the viewpoint of security.

When the acquisition unit 12 acquires the token from the server apparatus 30, the token is stored in the storage unit 13. Typically, the token has an expiration period. When the acquisition unit 12 acquires a plurality of tokens, the storage unit 13 stores, for example, token management information including a token, an expiration period of the token, and a target device of the token.

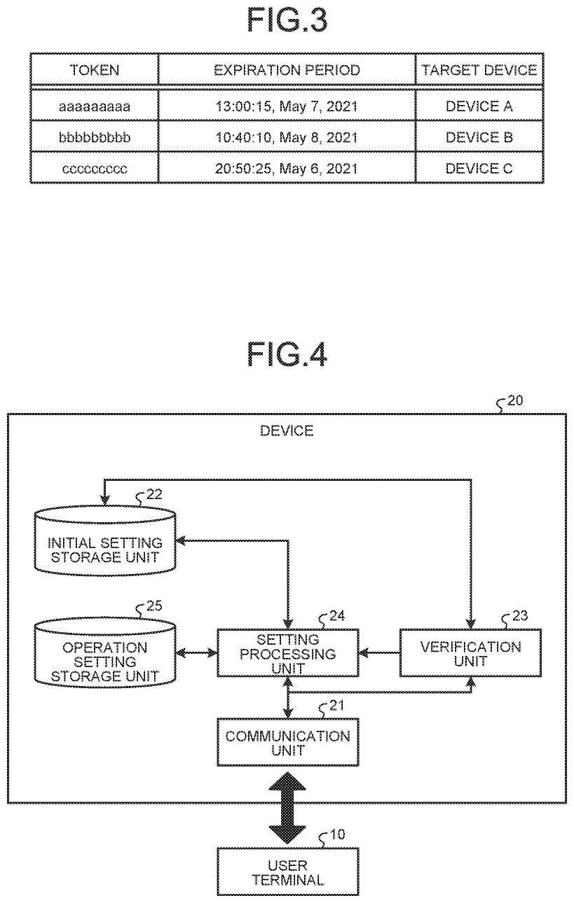

FIG. 3 is a view illustrating an example of the token management information of the first embodiment. The token management information of the first embodiment includes the token, the expiration period, and the target device. In the example of the token management information of FIG. 3, for example, it is managed that a token aaaaaaaaa whose expiration period is 13:00:15 on May 7, 2021 is used for a device A.

Returning to FIG. 2, the acquisition unit 12 may make an inquiry to the storage unit 13 before requesting the server apparatus 30 for the token, and may confirm whether or not there is a valid token associated with the target device 20. Then, when such a token exists, the acquisition unit 12 may not newly acquire a token from the server apparatus 30.

The transfer unit 14 starts transfer processing, for example, in response to an instruction from the acquisition unit 12 that has acquired the token from the server apparatus 30. Further, for example, the transfer unit 14 starts the transfer processing in response to an instruction from the acquisition unit 12 that has confirmed that the valid token exists in the storage unit 13. Furthermore, for example, the transfer unit 14 starts the transfer processing in response to an instruction by a user's operation input.

The transfer unit 14 acquires the token, associated with the device 20 that is a communication partner of the first communication unit 11a, from the storage unit 13, and transmits the acquired token from the first communication unit 11a to the device 20. Thereafter, when the transfer unit 14 receives a message addressed to the server apparatus 30 from the device 20, the transfer unit 14 transfers the message to the server apparatus 30.

When the transfer unit 14 receives a message addressed to the device 20 from the server apparatus 30, the transfer unit 14 transfers the message to the device 20. The token may be transmitted once from the transfer unit 14 to the device 20 immediately before a series of message transfers is started, or may be transmitted every time a message is transferred.

When the transfer unit 14 receives a message transfer end notification from the device 20 or the server apparatus 30, the transfer unit 14 ends a series of transfer processing. Furthermore, when the transfer unit 14 does not receive the message from the device 20 or the server apparatus 30 for a certain period of time, the transfer unit 14 may autonomously end a series of transfer processing.

Example of Functional Configuration of Device

FIG. 4 is a view illustrating an example of a functional configuration of the device 20 of the first embodiment. The device 20 of the first embodiment includes a communication unit 21, an initial setting storage unit 22, a verification unit 23, a setting processing unit 24, and an operation setting storage unit 25.

The communication unit 21 communicates with the user terminal 10.

The initial setting storage unit 22 stores an initial setting of the device 20. Here, the initial setting is typically a setting that the device 20 has at the time of factory shipment. The initial setting includes server authentication information and the device information.

The server authentication information includes, for example, at least one of the server certificate of the server apparatus 30 and a public key of the server apparatus 30.

The device information includes, for example, the model, the serial number, the MAC address, a public key and private key pair of the device 20, and the like of the device 20. The initial setting of the device 20 is set in the initial setting storage unit 22 at the time of manufacturing the device 20, for example.

The initial setting storage unit 22 is, for example, a nonvolatile memory having tamper resistance. For example, after power is turned on, the device 20 enters a reception state of initialization processing by the initial setting read from the initial setting storage unit 22, and when the initialization processing is completed, the device operates with the initial setting until operation setting is performed.

The verification unit 23 verifies the token received from the user terminal 10 via the communication unit 21. The server authentication information stored in the initial setting storage unit 22 is used to verify the token. In order to prevent a replay attack due to retransmission of the verified token, information of a token verified in the past may also be used for token verification in addition to the server authentication information. For example, a sequence number is assigned to the token, and information of the token verified in the past may be determined by the sequence number. Specifically, when the verification unit 23 verifies the token, the verification unit 23 stores the sequence number in a nonvolatile memory (for example, the operation setting storage unit 25) or the like of the device 20. Then, when the next token is verified, the verification unit 23 determines whether the token to be verified has been verified in the past by comparing the sequence number assigned to the token with the sequence number stored in the nonvolatile memory or the like.

The communication unit 21 and the verification unit 23 may receive and verify the token, for example, when the device 20 receives a predetermined operation. The predetermined operation is, for example, power on while pressing a button of the device 20 or long press operation of the button.

For example, the device 20 in a factory shipment state may always perform token reception operation and may verify the token when the token is received.

When the token is successfully verified by the verification unit 23, the setting processing unit 24 transmits a message to the server apparatus 30 via the communication unit 21. This message may be encrypted with information included in the token. For example, the token may include an encryption key encrypted with the public key of the device 20, and the communication unit 21 may encrypt a message exchanged with the server apparatus 30 using the encryption key or may add authentication data of the message. For example, the communication unit 21 may generate an encryption key of the device 20, encrypt the encryption key with the public key of the server apparatus 30, include the encryption key in a first message transmitted from the device 20 to the server apparatus 30, and perform protection using the encryption key in subsequent messages. In any case, the device 20 and the server apparatus 30 use information held by each other in advance, protect mutual messages, conceal all or a part of the messages also to other communication apparatuses including the user terminal 10 that transfers the messages, and protect from an attack such as tampering by other communication apparatuses.

The device 20 requests the server apparatus 30 to perform setting necessary for the subsequent operation. The setting necessary for the operation includes setting for connecting the device 20 to the network 200, setting unique to a system with which the device 20 cooperates, and the like.

When the device 20 connects to a Wi-Fi network, the setting for connecting to the network 200 is, for example, a network identifier or a password thereof, a certificate of the device 20 for the network, or the like. When the device 20 is connected to a cellular network, the setting includes a carrier, an access point name, a user name, a password, and the like to be connected. In addition, when an IP address, a gateway, information of a DNS server, and the like used by the device 20 are not automatically given from the network, these may also be provided from the server apparatus 30 as setting for connecting to the network.

The setting unique to the system with which the device 20 cooperates is typically setting of an application, and includes an identifier or a URL of an application server of a destination of cooperation of the device 20, a server certificate thereof, and public key information. For example, the setting unique to the system with which the device 20 cooperates includes the identifier and the password of the device 20, the certificate of the device 20, and the like used in cooperation with the application server.

When the initial setting storage unit 22 does not have the private key and the public key of the device 20, the private key and the public key of the device 20 may be generated in the exchange between the setting processing unit 24 and the server apparatus 30, and the public key may be transmitted from the setting processing unit 24 to the server apparatus 30 and registered in the server apparatus 30. In addition, as a result, a public key certificate of the device 20 may be provided from the server apparatus 30 to the setting processing unit 24.

The operation setting storage unit 25 is, for example, a nonvolatile memory having tamper resistance. The operation setting storage unit 25 manages and holds information acquired or generated during the exchange between the setting processing unit 24 and the server apparatus 30. Then, the device 20 performs connection to the network 200 and cooperation with the system by using setting information managed and held by the operation setting storage unit 25.

Example of Functional Configuration of Server Apparatus

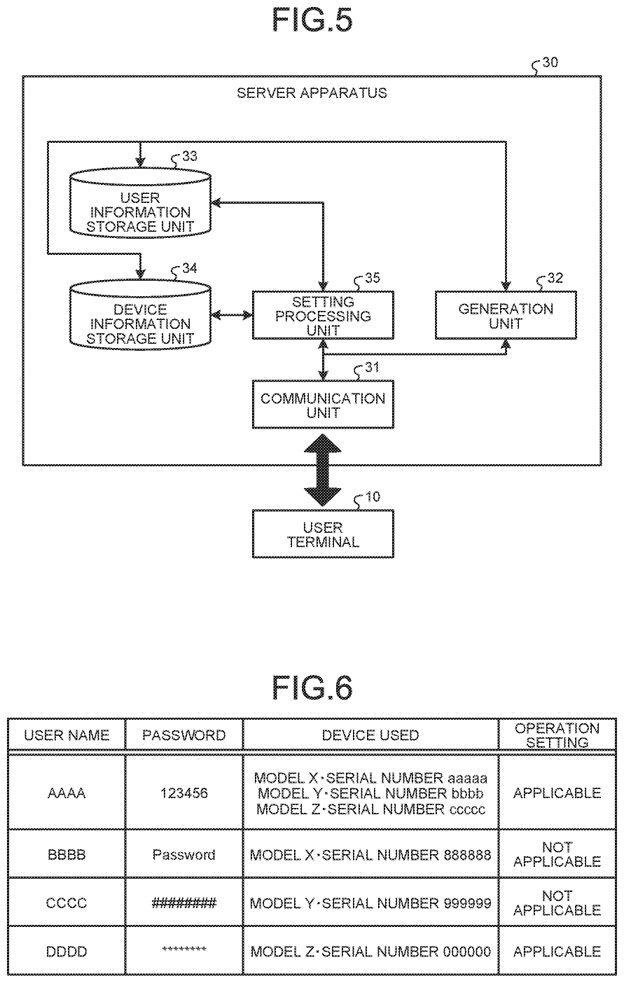

FIG. 5 is a view illustrating an example of a functional configuration of the server apparatus of the first embodiment. The server apparatus 30 of the first embodiment includes a communication unit 31, a generation unit 32, a user information storage unit 33, a device information storage unit 34, and a setting processing unit 35.

The communication unit 31 communicates with the user terminal 10.

The generation unit 32 generates a token (an example of authorization information). Information used to verify validity of the token on the device 20 side may be embedded in the token. For example, information generated by the private key of the server apparatus 30 may be embedded in the token.

The generation unit 32 provides the token to the user terminal 10 via the communication unit 31. Specifically, the generation unit 32 receives the token request from the user terminal 10. The token request includes all or part of the information of the user terminal 10, the user information, and the device information. The generation unit 32 determines whether or not the token request is a valid token request based on information included in the token request and the user information stored in the user information storage unit 33. Then, when the token request is the valid token request, the generation unit 32 generates a token for the target device 20 and provides the token to the user terminal 10 via the communication unit 31.

The user information storage unit 33 stores the user information used by the generation unit 32 when verifying the validity of the token request from the user terminal 10.

FIG. 6 is a view illustrating an example of the user information of the first embodiment. The user information of the first embodiment includes, for example, the user name, the password, a device used, and the operation setting. The user name is a name of the user. The password is a password used by the user. The device used is a device used by the user.

The operation setting indicates whether the operation setting for the device used by the user is enabled. When the authentication of the user terminal 10 succeeds, the generation unit 32 determines whether or not the user of the user terminal 10 is enabled to perform the operation setting of the device 20 by using the information indicating whether the operation setting is enabled, and generates the authorization information when the operation setting of the device 20 can be performed.

The user information is not limited to the example of FIG. 6. For example, instead of the password, the public key or the user certificate of the user may be included in the user information. For example, the model or the serial number of the user terminal 10 used by the user may be further included in the user information. For example, only the serial number for the device used may be managed by the user information.

In any case, the generation unit 32 compares the information provided when the token request is received from the user terminal 10 with the information included in the user information storage unit 33, and determines that the token request is valid when the information sufficiently matches.

Returning to FIG. 5, for example when the encryption key for protecting exchange with the device 20 is encrypted with the public key of the device 20 and embedded in the token, the generation unit 32 inquires of the device information storage unit 34.

The device information storage unit 34 manages, for each of the devices 20, the information unique to the device 20 (for example, MAC address, public key, etc.) as device information, in addition to the model and the serial number of the device 20. If there is supplementary information (for example, the identifier of the encryption key, the expiration period, etc.) together with the value of the encryption key used in the exchange with the device 20, the device information storage unit 34 manages the value of the encryption key and the supplementary information as the device information for each of the devices 20. Further, the device information storage unit 34 also manages setting information and the like, used when the device 20 is operated, as the device information.

The setting processing unit 35 reads the device information from the device information storage unit 34 and provides the device information to the device 20 via the user terminal 10. The device information is provided after the setting processing unit 35 receives the message transmitted from the device 20 to the server apparatus 30.

Example of Communication Method

FIG. 7 is a sequence diagram illustrating an example of a communication method of the first embodiment. First, the device 20 receives operation for placing the device 20 in an operation setting standby state (step S1). For example, the device 20 enters a reception state (standby state) of operation setting processing for a certain period of time by a predetermined operation such as a long press of a power button.

Next, the user terminal 10 transmits the above-described token request to the server apparatus 30 according to an operation input of the user or the like (step S2). Next, the server apparatus 30 verifies the validity of the message (token request) (step S3). In the verification processing in step S3, whether the operation setting for the device used by the user is enabled may also be determined. When whether the operation setting is enabled is also determined, the server apparatus 30 does not issue the token to the device 20 for which the operation setting is not enabled.

Next, when the message is valid, the server apparatus 30 issues the token (step S4). Next, the user terminal 10 presents the token issued in step S4 to the device 20 in the operation setting standby state via the first communication unit 11a (step S5). Next, the device 20 and the server apparatus 30 perform the operation setting processing of the device 20 via the user terminal 10 (step S6). The operation setting processing includes, for example, transmission and reception of operation setting data necessary for performing the operation setting of the device 20. Next, when the operation setting processing in step S6 ends, the server apparatus 30 transmits an operation setting completion notification to the user terminal 10 (step S7)

As described above, the communication system 100 of the first embodiment includes the device 20, the server apparatus 30, and the user terminal 10. The device 20 includes the setting processing unit 24, the communication unit 21, and the operation setting storage unit 25. When the setting processing unit 24 receives the authorization information generated by the server apparatus 30 from the user terminal 10, the setting processing unit 24 executes operation setting processing of setting the operation setting of the device 20. The communication unit 21 encrypts the operation setting data transmitted from the device 20 in the operation setting processing and transmits the operation setting data to the user terminal 10. The operation setting storage unit 25 stores the operation setting set by the operation setting processing. The server apparatus 30 includes the generation unit 32 and the communication unit 31. When the authentication of the user terminal 10 succeeds, the generation unit 32 generates the authorization information. The communication unit 31 encrypts the operation setting data transmitted from the server apparatus 30 in the operation setting processing and transmits the operation setting data to the user terminal 10. The user terminal 10 includes the acquisition unit 12, the transfer unit 14, and the communication unit 11. The acquisition unit 12 performs authentication with the server apparatus 30, and acquires the authorization information from the server apparatus 30 when the authentication succeeds. The transfer unit 14 transfers the authorization information to the device 20 and then transfers the operation setting data between the device 20 and the server apparatus 30. When the operation setting is completed, the communication unit 11 receives a completion notification from at least one of the device 20 and the server apparatus 30.

As a result, according to the communication system 100 of the first embodiment, it is possible to prevent unauthorized setting on the device 20 by the malicious user terminal 10. For example, according to the communication system 100 of the first embodiment, the device 20 in the factory shipment state (initial setting state) can reject the setting from the attacker without disclosing the details of the setting to the user while accepting the setting processing from the trusted user.

Conventionally, for example, a method using DPP cannot prevent unauthorized setting on the device 20 by the malicious user terminal 10 capable of reading the QR code (registered trademark) of the device 20.

The trusted user is, for example, a field engineer, a user who receives the infrastructure service, or the like at an installation site of the device 20 with individual setting of the device 20 for infrastructure service, for example, detailed setting of an individual encryption key and a connection destination cloud service.

For example, in the device 20 for infrastructure service, the device 20 in the factory shipment state has only minimum individual information (such as serial number) set, and the device 20 does not operate as a part of the infrastructure service in the state as it is. According to the first embodiment, when the token received via the user terminal 10 is issued by the correct server apparatus 30 (for example, cloud service), the device 20 in the factory shipment state performs the operation setting with the server apparatus 30. At this time, since the user terminal 10 only transfers the message between the device 20 and the server apparatus 30, the content of the message can be prevented from being disclosed to the user terminal 10 (the content of the message is concealed by encryption processing). Then, when a set of operation settings is completed, a completion notification is transmitted from at least one of the server apparatus 30 and the device 20 to the user terminal 10.

### Second Embodiment

Next, a second embodiment will be described. In the description of the second embodiment, the description similar to that of the first embodiment will be omitted, and portions different from those of the first embodiment will be described. In the second embodiment, a case where the user terminal 10 has only one network interface will be described.

Example of Functional Configuration of User Terminal

FIG. 8 is a view illustrating an example of a functional configuration of a user terminal 10 of the second embodiment. The user terminal 10 of the second embodiment includes a communication unit 11, an acquisition unit 12, a storage unit 13, and a transfer unit 14. In the second embodiment, the user terminal 10 has only one communication unit 11. For example, in a mode in which the user terminal 10 and the device 20 are connected to the same LAN and the LAN is connected to a network 200, the configuration of the user terminal 10 is as illustrated in FIG. 8.

### Third Embodiment

Next, a third embodiment will be described. In the description of the third embodiment, the description similar to that of the first embodiment will be omitted, and portions different from those of the first embodiment will be described. A generation unit 32 of a server apparatus 30 of the third embodiment stores a message verification result of a token request from a user terminal 10 in a nonvolatile memory. As a result, the fact that a valid token request has been received and the fact that an invalid token request has been received can be confirmed later. A verification result of the token may be stored together with time information indicating a time when verification is performed.

### Fourth Embodiment

Next, a fourth embodiment will be described. In the description of the fourth embodiment, the description similar to that of the first embodiment will be omitted, and portions different from those of the first embodiment will be described. When a verification unit 23 of a device 20 of the fourth embodiment receives an invalid token, the verification unit 23 stores the fact in a nonvolatile memory. As a result, the fact that the invalid token has been received can be confirmed later. A reception record of the invalid token may include time information indicating a reception time.

Finally, an example of a hardware configuration of each of the user terminal 10, the device 20, and the server apparatus 30 of the first to fourth embodiments will be described.

Example of Hardware Configuration

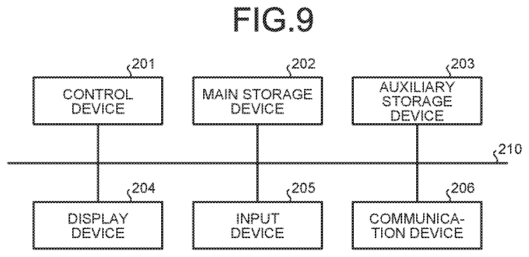

FIG. 9 is a view illustrating an example of a hardware configuration of main parts of the user terminal 10, the device 20, and the server apparatus 30 of the first to fourth embodiments. The user terminal 10, the device 20, and the server apparatus 30 of the first to fourth embodiments include a control device 201, a main storage device 202, an auxiliary storage device 203, a display device 204, an input device 205, and a communication device 206. The control device 201, the main storage device 202, the auxiliary storage device 203, the display device 204, the input device 205, and the communication device 206 are connected via a bus 210.

The user terminal 10, the device 20, and the server apparatus 30 of the first to fourth embodiments may not include a part of the above configuration. For example, when the device 20 is a sensor or the like provided as a part of the infrastructure service, the display device 204 and the input device 205 may not be provided.

Since the hardware configurations of the main parts of the user terminal 10, the device 20, and the server apparatus 30 are similar, a case of the user terminal 10 will be described as an example in the following description.

The control device 201 executes a program read from the auxiliary storage device 203 to the main storage device 202. The main storage device 202 is a memory such as a ROM and a RAM. The auxiliary storage device 203 is a hard disk drive (HDD), a memory card, or the like.

The display device 204 is, for example, a liquid crystal display or the like. The input device 205 is an interface for operating the user terminal 10. The input device 305 is, for example, a keyboard, a mouse, a button provided in a housing of the user terminal 10, or the like. The display device 204 and the input device 205 may be realized by a touch panel or the like having a display function and an input function.

The communication device 206 is an interface for communicating with other devices.

The program executed by the user terminal 10, the device 20, and the server apparatus 30 is recorded in an installable or executable file format on a computer-readable storage medium such as a CD-ROM, a memory card, a CD-R, or a DVD, and is provided as a computer program product.

In addition, the program executed by the user terminal 10, the device 20, and the server apparatus 30 may be stored in a computer connected to a network such as the Internet and provided by being downloaded via the network. The program executed by the user terminal 10, the device 20, and the server apparatus 30 may be provided via a network such as the Internet without being downloaded.

The program of the user terminal 10, the device 20, and the server apparatus 30 may be incorporated in advance in a ROM or the like and provided.

The program executed by the user terminal 10, the device 20, and the server apparatus 30 has a module configuration including a function that can also be realized by the program among functional configurations in FIGS. 2, 4, 5, and 8 described above. In each of the functions, as actual hardware, each of the functional blocks is loaded on the main storage device 202 by the control device 201 reading and executing the program from the storage medium. That is, each of the functional blocks is generated on the main storage device 202.

Some or all of the functions in FIGS. 2, 4, 5, and 8 described above may not be implemented by software, but may be implemented by hardware such as an IC.

When each function is realized by using a plurality of processors, each processor may realize one of the functions or may realize two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising:
a device;
a server apparatus; and
a user terminal, wherein
the device includes:
a setting processing unit that executes operation setting processing of setting operation setting of the device when receiving authorization information generated by the server apparatus, from the user terminal;
a communication unit that encrypts operation setting data to be transmitted from the device in the operation setting processing and transmits the encrypted operation setting data to the user terminal; and
an operation setting storage unit that stores the operation setting set by the operation setting processing,
the server apparatus includes:
a generation unit that generates the authorization information when authentication of the user terminal succeeds; and
a communication unit that encrypts operation setting data to be transmitted from the server apparatus in the operation setting processing and transmits the encrypted operation setting data to the user terminal, and
the user terminal includes:
an acquisition unit that performs the authentication with the server apparatus, and acquires the authorization information from the server apparatus when the authentication succeeds;
a transfer unit that transfers the authorization information to the device and then transfers the operation setting data between the device and the server apparatus; and
a communication unit that receives a completion notification from at least one of the device and the server apparatus when the operation setting is completed.

2. The system according to claim 1, wherein the device enters a reception state of the operation setting processing for a certain period of time by a predetermined operation.

3. The system according to claim 1, wherein
the device further includes an initial setting storage unit that stores initial setting of the device, and
the device enters a reception state of initialization processing by the initial setting after power is turned on.

4. The system according to claim 3, wherein
the initial setting includes server authentication information including at least one of a server certificate of the server apparatus and a public key of the server apparatus, and
the device further includes a verification unit that verifies validity of the authorization information received from the server apparatus via the user terminal, using the server authentication information.

5. The system according to claim 4, wherein
the authorization information is a token to which a sequence number is assigned,
the operation setting storage unit stores a sequence number of a token used in the operation setting processing that has already been executed, and
the verification unit verifies validity of a token by comparing a sequence number assigned to the token with the sequence number stored in the operation setting storage unit.

6. The system according to claim 1, wherein
the server apparatus further stores a user information storage unit that stores user information of a user who uses the user terminal, and
the generation unit authenticates the user terminal by using the user information.

7. The system according to claim 6, wherein
in the user information, information indicating whether the operation setting of the device is enabled is set for each user, and
when authentication of the user terminal succeeds, the generation unit determines whether or not the user of the user terminal is enabled to perform the operation setting of the device by using information indicating whether the operation setting is enabled, and generates the authorization information when the user is enabled to perform the operation setting of the device.

8. A communication method of a communication system comprising a device, a server apparatus, and a user terminal, the communication method comprising:
executing, by the device, operation setting processing of setting operation setting of the device when receiving authorization information generated by the server apparatus, from the user terminal;
encrypting, by the device, operation setting data to be transmitted from the device in the operation setting processing and transmitting the encrypted operation setting data to the user terminal;
storing, by the device, the operation setting set by the operation setting processing;
generating, by the server apparatus, the authorization information when authentication of the user terminal succeeds;
encrypting, by the server apparatus, operation setting data to be transmitted from the server apparatus in the operation setting processing and transmitting the encrypted operation setting data to the user terminal;
performing, by the user terminal, authentication with the server apparatus, and acquiring the authorization information from the server apparatus when the authentication succeeds;
transferring, by the user terminal, the authorization information to the device and then transferring the operation setting data between the device and the server apparatus; and
receiving, by the user terminal, a completion notification from at least one of the device and the server apparatus when the operation setting is completed.
